(19) United States
(12) Patent Application Publication
(10) Pub. No.: US 2006/0212330 A1
(43) Pub. Date: Sep. 21, 2006

(54) Network based processing of calendar meeting requests

(76) Inventor: Erkki Savilampi, Lempaala (FI)

Correspondence Address: ROBERT M BAUER, ESQ.;LACKENBACH SIEGEL, LLP, 1 CHASE ROAD, SCARSDALE, NY, 10583, US

(21) Appl. No.: 11/082,159

(22) Filed: Mar. 16, 2005

(51) Int. Cl. G06F 17/60

(52) U.S. Cl. 705/8

(57) ABSTRACT

A meeting request is created by one of a group of users having respective electronic calendars maintained by calendar applications on a communications network and is processed before being forwarded to any of the users invited to the requested meeting. The processing occurs through interaction between the calendar applications of the users and other elements connected to the communications network, without any interaction by any of the users. The processing consists of checking information available on or through the network to determine if the requested meeting is on a day that is a holiday for one or more invited users. Either a database of previously stored country specific holidays or holiday information entered by the invited users on their calendar is accessed to conduct the check. Although the meeting request is transferred and processed over the network to check for holidays, it is only forwarded and displayed to the invited users after the processing has been completed The user creating the meeting request may be informed of the result of the processing in all cases, or only when there is an unacceptable result, such as by a display message on their terminal.

### FIELD OF THE INVENTION

The present invention relates to calendar applications operating over a communications network. In particular, the invention relates to the processing of calendar meeting requests by software applications that enable a group of multiple users to maintain respective calendars and make meeting requests over a communications network.

### BACKGROUND OF THE RELATED ART

There are various software applications that provide users with the capability to maintain personal electronic calendars on a local area network or on a personal computer or other type of user terminal that is connected to a local area network. Some software applications, known as Personal Information Management (PIM) applications, integrate the electronic calendar with other functions such as contacts, email and other types of messaging. Calendar information can be passed between different applications using a data format such as vCalendar and iCalendar. Exemplary software applications for users of Windows based computers in an enterprise environment include LotusNotes and Microsoft Outlook. Similar software applications are also available for Palm based mobile terminals and for the Symbian-based 9000 Communicator series of mobile terminals from Nokia Corporation.

Some software applications include a feature that facilitates the scheduling of meetings. Not only can a user maintain their own personal calendar, but calendaring information in a known data format may be exchanged between the calendar applications of different users. For example, a meeting requester may be able to check the availability of the invitees before sending a meeting request. FIG. 1 shows the option to set up a meeting in Microsoft Outlook where the calendars of the invited users are displayed to the meeting organizer in a format that shows the status of the invited user by day and time (in one hour increments). The status information indicates whether the user is tentatively available, busy, or out of the office. Each user has the option of selecting whether or not to let other users have rights to read/edit their calendar. Thus, information other than status information may or may not be available to the meeting requester. It is also possible for a user to set the time zone for their calendar or to add country specific holidays to their local calendar. FIG. 2 shows how to add holidays into a user's calendar in Microsoft Outlook. This addition of holidays has the disadvantage that the status information of the user is not updated according to the added holidays and cannot be used by the meeting requester when scheduling a meeting.

Enterprises and other organizations (both large and small), and subgroups thereof, can be widely geographically distributed, with users living, working and traveling in many different countries. Consequently, even a user who checks the availability of invited users before requesting a meeting may not know which invited users are in which countries, or even so, when holidays occur in those countries. Indeed, a user requesting a meeting may not know the holidays of the country in which they themselves are temporarily located or traveling or the country in which the requested meeting is to take place. While options may be available to set holidays, time zone or other information, users frequently fail to utilize the available options and may have incorrect holiday, time zone or other settings on their calendar. Users who are temporarily relocated or traveling in another country may not know what days are holidays in that country and/or their local calendar may not be updated to reflect their current country/time zone.

A further disadvantage is that the status information of a user provided in the meeting request calendar screen may be misleading or inadequate. For example, if the invited user has incorrect time zone settings on their calendar, then the status information will be offset in time. Another problem is that appointments may be incompletely entered on users' calendars or, in particular, entered without correct status information, in which case the calendar may indicate the user is available when they are not. The incorrect status information may be caused, for example, because there is a default value provided for the status information and the user fails to change the status information to the correct value. Also, some annual recurring events such as anniversaries and birthdays may be marked as free (see FIG. 3 for an example). The day may not be suitable for a meeting, but it would not be shown on the meeting request calendar screen because it's marked as free rather than busy. If the recurring event were saved with a busy status, the meeting requester may not request a meeting on that date. Since only status information is provided, the meeting requester does not know such background information and cannot use it when considering a meeting request.

### BRIEF SUMMARY

According to the preferred embodiments described herein, a meeting request is created by one of a group of users having respective electronic calendars maintained by calendar applications on a communications network and is processed before being forwarded to any of the users invited to the requested meeting. The processing occurs through interaction between the calendar applications of the users and other elements connected to the communications network, without any interaction by any of the users. The processing may consist of checking supplemental information on the network to determine if the requested meeting is on a day that is a holiday of some type for one or more invited users. Either a database of previously stored country specific holidays or holiday information entered by the invited users on their calendar may be accessed to conduct the check. Although the meeting request is transferred and processed over the network to check for holidays, it is only forwarded and displayed to the invited users after the processing has been completed The user creating the meeting request may be informed of the result of the processing in all cases, or only when there is an unacceptable conflict due to holidays, such as by a display message on their terminal.

### BRIEF DESCRIPTION OF THE DRAWINGS

FIG. 1 is an example display of the availability of various users invited to a requested meeting in a prior art calendar application.

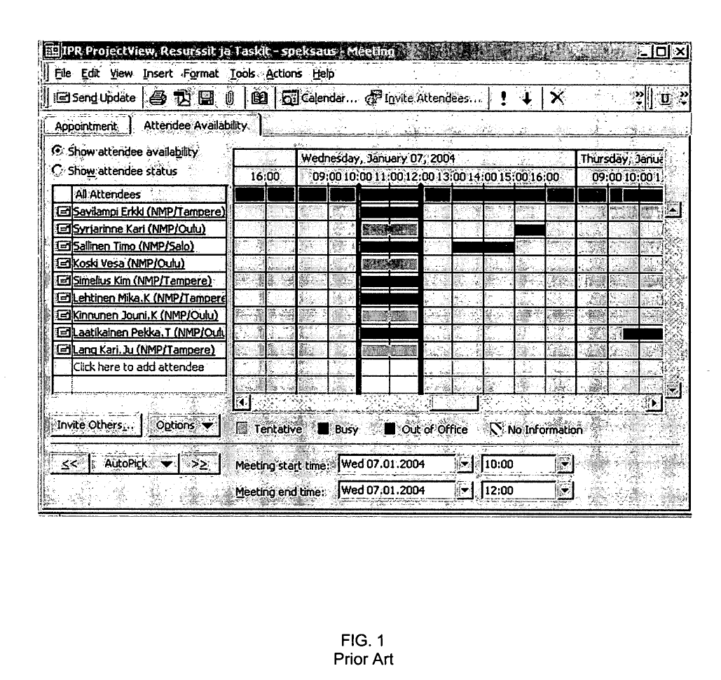

FIG. 2 is a display of the option of adding holidays in a prior art calendar application.

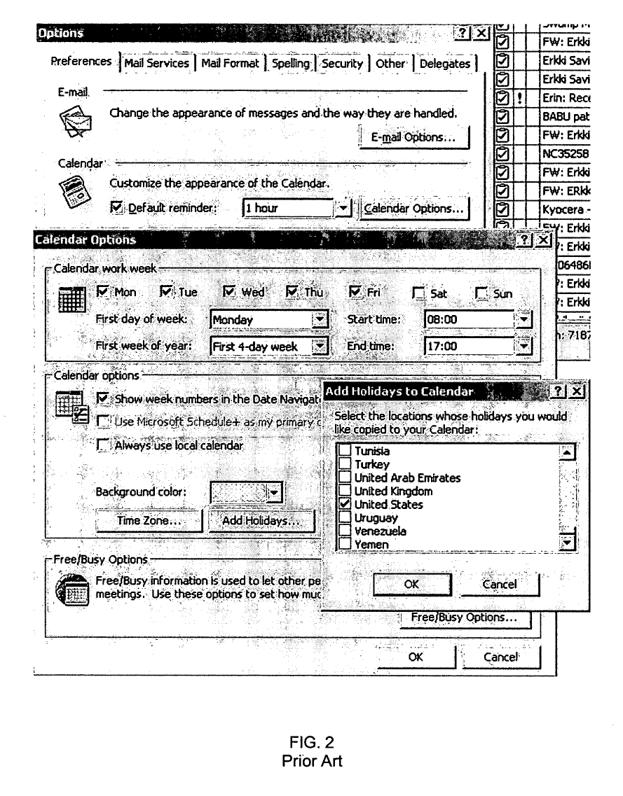

FIG. 3 is a display of an example calendar event that may be missed when scheduling a meeting in a prior art calendar application.

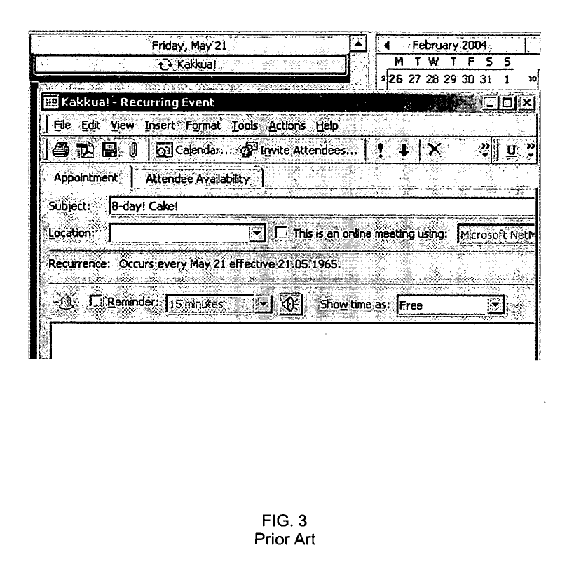

FIG. 4 is a diagram illustrating the possible communication paths between a mobile terminal and a server containing a calendar database according to a preferred embodiment of the invention.

FIG. 5 is a functional block diagram of the mobile terminal in the preferred embodiment of FIG. 4.

FIG. 6 is a flowchart showing the network based processing of a meeting request according to a preferred embodiment of the invention.

### DESCRIPTION OF THE PREFERRED EMBODIMENTS

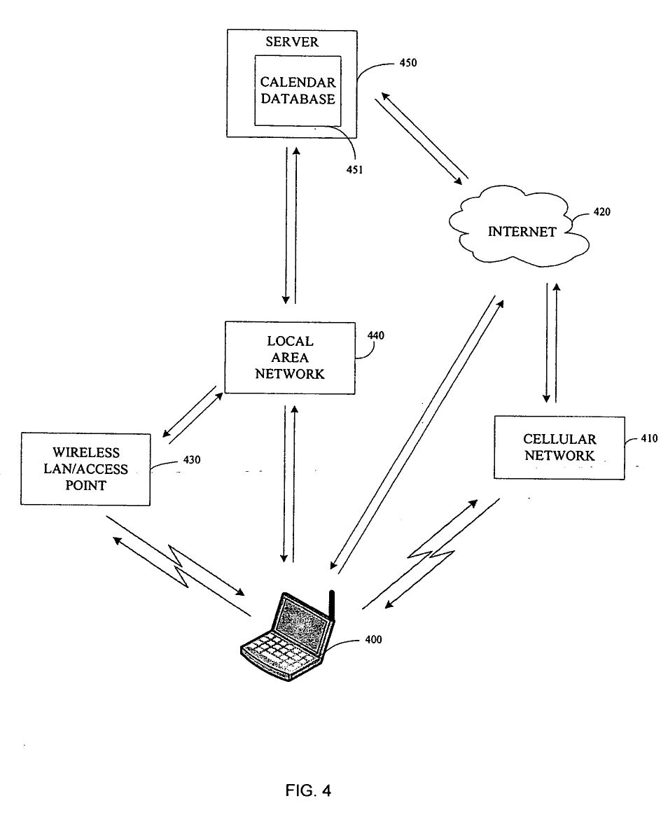

Various preferred embodiments of the invention will now be described with reference to FIGS. 4-6, noting that such embodiments are exemplary and non-limiting. For example, although the preferred embodiments are described with reference to a multi-network mobile terminal configured to be carried in a person's pocket or by hand, any type of user terminal, such as a personal computer, may be utilized. Although the user terminal is shown and described as being able to utilize any one of a number of different access networks and communication networks, a user terminal in any particular embodiment of the invention may have different network connectivity. In particular, although a wireless network is specifically addressed in the description, the preferred embodiments may be implemented in a network environment consisting solely of a local area network or other network having no wireless components. Numerous other details are also discussed with respect to the preferred embodiments, and the invention is likewise not limited to such details.

As shown in FIG. 4, mobile terminal 400 may be able to connect to and be interoperable with a cellular network 410, the Internet 420 through an Internet Service Provider (not shown), a wireless local area network (WLAN) or wireless access point 430, or a local area network 440 (such as an Ethernet network). Calendaring server 450 preferably has separate interfaces so that it can be accessed as a network resource on LAN 440 or from Internet 420. It may include calendar database 451, which stores one or more electronic calendars shared by a plurality of users and/or personal calendars of one or more individual users who have their calendar stored in calendaring server 450 rather than locally at their user terminal. Although server 450 is referred to herein as a calendaring server, such a server is not necessarily restricted to executing only a calendar application and may include other applications as well, such as an email application or PIM application.

Mobile terminal 400 may be selectively authenticated and authorized with any one or all of the networks and with server 450 upon network connection. A suitable example of mobile terminal 400 is the 9500 Communicator available from Nokia Corporation of Espoo, Finland. Although a single mobile terminal is shown in FIG. 4, it should be understood that there are a number of user terminals of various types and network connectivity that are authenticated and authorized to be interoperable with the network and with server 450. Similarly, although only a single calendaring server 450 is shown in FIG. 4, it should be understood that there may be any number of calendaring servers located anywhere in the entire network topology and preferably will be a number of widely distributed calendaring servers to serve a number of widely distributed users.

Although shown in FIG. 4 as being connected directly to LAN 440, mobile terminal 400 may be indirectly connected through a computer or other terminal on LAN 440 that includes a calendar application compatible with the calendar application in mobile terminal 400 and the two calendar applications may be synchronized through Bluetooth, infrared, USB (Universal Serial Bus) or any other connection. The user can then communicate with server 450 using such computer or other terminal on LAN 440 even if the mobile terminal itself cannot access LAN 440 or server 450.

There may also be any type or configuration of WLAN or wireless access point 430 so that mobile terminal 400 may communicate with server 450 without a direct connection to LAN 440. The communication between mobile terminal 400 and WLAN/wireless access point 430 may be conducted pursuant to “Wi-Fi” (802.11 a/b/g/n) or any other suitable standard currently existing or hereafter developed. WLAN 430 may vary from a single wireless access point connected to LAN 440 to an extensive managed wireless network.

The mobile terminal 400 contains communications hardware and software to be able to adaptively perform communication operations in order to connect to each network in the appropriate manner. Furthermore, mobile terminal 400 utilizes processing circuitry that can be utilized to execute software applications that perform functions other than the communication operations. Therefore, the mobile terminal 400 may be capable of storing and executing software applications having many of the same functions as a personal computer Among the software applications executed by mobile terminal 400 is a calendar application operating as described in this application. The calendar application accesses, displays, updates, and otherwise manages a personal calendar associated with the user of the mobile terminal. It may display the personal calendar in any one of a plurality of different views selectable by the user. Furthermore, the calendar application permits individual calendar items to be selected and opened.

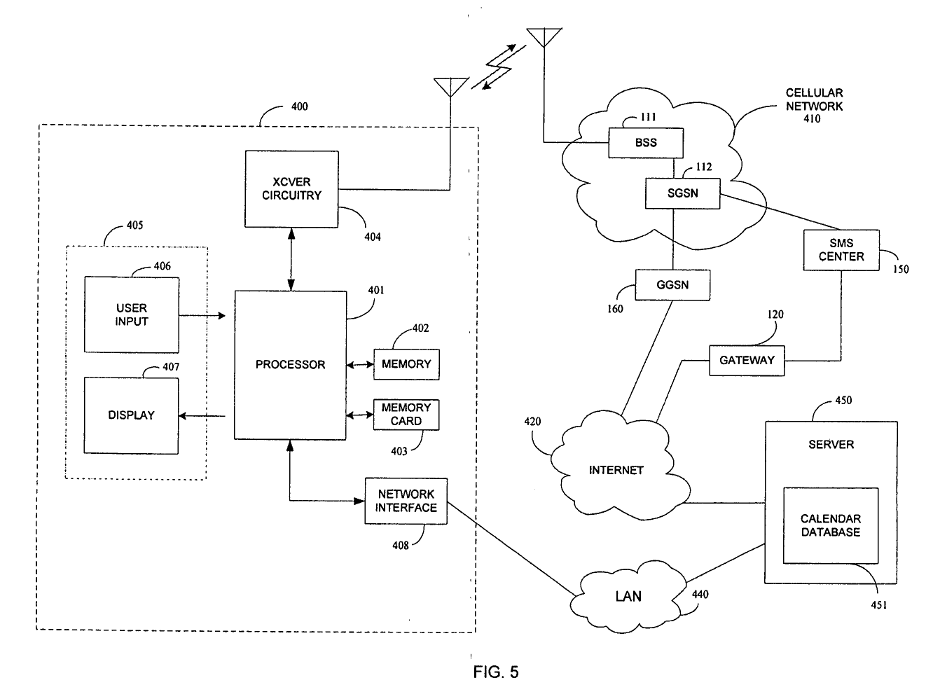

Exemplary details of mobile station 400 and cellular network 410 are shown in FIG. 5.

Mobile terminal 400 includes a network interface 408 capable of providing communications with LAN 440. Separate transceiver circuitry 404 capable of receiving and transmitting, respectively, communication signals with cellular network 410 by way of an antenna. The same antenna, and perhaps also transceiver circuitry 404, may also be used so that mobile terminal 400 may communicate with WLAN/wireless access point 430. The mobile station 400 is operable to effectuate circuit-switched communications by way of the downlink and uplink and further operable to communicate SMS messaging and also to effectuate GPRS operations. SMS messages and GPRS operations are performed upon shared uplink and downlink channels upon which packets of data are communicated with the mobile station.

Cellular network 410 is capable of providing both voice and data communications and may include, for example, a GSM (Global System for Mobile Communications) access network providing GPRS (General Packet Radio Service) and SMS (Short Message Service) data communications. When communicating with cellular network 410, mobile terminal 400 comprises a mobile station operating according to the appropriate standard to communicate over radio downlink and uplink with an element of cellular network 410, such as a base station. The cellular network 410 may include a base station system 111 and an SGSN (Serving GPRS Support Node) 112. The elements of the network infrastructure of the cellular network 110 are operable in a conventional manner and provide transceiving switching, and routing functions.

The SGSN 112, in turn, is coupled, in conventional manner to a GGSN (Gateway GPRS Support Node) 160. In turn, the GGSN 160 is coupled to a packet data network, such as the Internet 420. A server 450 containing calendar database 451 is coupled, in conventional manner, to the packet data network. Access to the contents of the calendar database is effectuated pursuant to retrieval operations by, e.g., TCP/IP (Transport Control Protocol) requests over Internet 420 or LAN 440. A SMS (Short Message Service) center 150 is further shown in the figure. In conventional manner, the SMS center 150 is coupled to the cellular network 410 and to the packet data network, by way of a gateway 120. The SMS center functions as a store and forward center for storing and forwarding SMS messages generated during operation of the communication system.

Return now to the processing environment of mobile station 400, there is a user interface 405, including user input devices 406 that may be selectively operated by a user of the mobile station. The user interface also includes a display device 407, which may be a LCD (Liquid Crystal Display) element. The user input 406 and display 407 are not necessarily completely separate and portions thereof may be combined, such as with a touch screen display wherein the user can provide input through contact with the display. The user input actuator 406 and the display 407 are coupled to processor circuitry 401. The processor circuitry 401 controls operation of the mobile station 400, including transceiver circuitry 404, responsive to user inputs 406. The controller is also operable to effectuate the generation of displays on display 407.

The mobile station further includes memory 402 operable together with processor circuitry 401. The memory 402 may include read-only memory as well as read/write memory to permit data, calendar items, retrieved from elsewhere, or generated through actuation of selected actuation keys of the user input 106 to be stored thereat and to be updated, as appropriate. There is preferably also separate removable memory or data storage, such as memory card 403, to facilitate data exchange.

The calendar application can be initiated and controlled by appropriate user inputs 406. The processor circuitry 401 of mobile terminal 400 is operable during execution of the calendar application, according to an embodiment of the present invention, to store and retrieve calendar items of the user at memory 402 or memory card 403 and to send or receive calendar related items to or from devices on the various connected networks, including calendaring servers, such as calendaring server 450. The calendar related items can be processed and displayed upon the display 407.

The calendar application may have a plurality of different screen formats. One screen format can be a daily or weekly listing of the user's calendar items, which may be indexed against a time-of-day index identified by a listing of successive hours of the day in a left-most column. Any one or more of the calendar items in the listing may be exportable to other calendar applications and calendar databases.

Another screen format of the calendar application is for the generation of a calendar meeting request. A meeting request is generated in the screen responsive to user inputs 406 interacting with elements on the meeting request screen. The requesting user can identify the users to be invited to the meeting (perhaps according to their email address), the day and time of the meeting, and the location of the meeting (or an indication of a telephone or video conference). One or more of the invited users may be designated as essential invited users. The processor 401 detects when the meeting request is completed and, in turn, causes the mobile terminal to generate a message, which is sent to calendaring server 450 through an appropriate network.

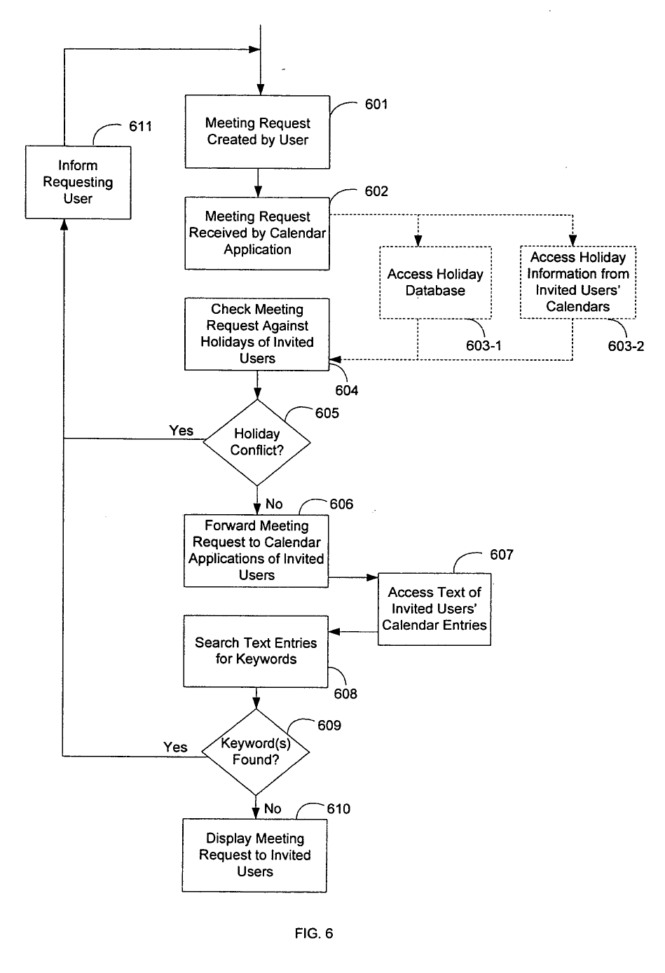

FIG. 6 shows the steps that occur in the processing of a meeting request according to the preferred embodiments of the invention. First, the user of mobile terminal 400 generates the meeting request at step 601 using the meeting request format displayed by the calendar application. When the user has completed the meeting request, they provide an input designating that the meeting request is complete. The mobile terminal 400 then generates a message containing the meeting request, and at step 602, the message is communicated to one or more calendaring servers, such as calendaring server 450, through an appropriate network. The meeting request is not communicated to the mobile terminal of any of the invited users at this time. There are several advantages to not forwarding the meeting request at this time. The amount of traffic on the network is reduced. Also, the invited users do not receive meeting requests that may not be appropriately scheduled and may be subsequently rescinded by the meeting requester.

The mobile terminal 400 preferably has no further involvement in the processing of the meeting request until the requested meeting is either scheduled or other information is provided to the user. Alternatively, the meeting request may be kept in mobile terminal 400, which may determine if there is a holiday or other conflict with the requested day and time for the meeting and/or perform other steps described in the following embodiment as being performed by the calendaring server receiving the meeting request.

After the message containing the meeting request has been transferred in step 602, calendaring server 450 then accesses country specific holiday information. The holiday information may be obtained from a holiday database as shown by step 603-1. The holiday database may be located in calendaring server 450, either as part of calendar database 451 or in a separate device connected to the network. The holiday information may also be obtained from the individual calendars of the invited users in step 603-2. The various invited users may have their calendars stored in their user terminal or in a separate calendaring server. If the holiday information is obtained from the calendar of an invited user stored in the user's mobile terminal, this is done without providing any indication to the invited user or requiring any interaction by the invited user. In a particular implementation, the holiday information may be obtained through only one of step 603-1 and 603-2. The holiday information may also be obtained by using both steps cumulatively, so that there is assumed to be a holiday if either one of the sources of holiday information indicates there is a holiday. The holiday information may also be obtained through some combination of step 603-1 and 603-2. For example, holiday information may be obtained from an invited user's calendar only if their calendar is stored in a server separate from the invited user's terminal.

In step 604, the meeting request is checked by the calendaring server 450 against the holiday information obtained in the previous step for the country of each invited user. The meeting request can alternatively be checked by mobile terminal 400 or by one or more other servers. For example, the meeting request can be checked by a server serving mobile terminal 400 or by a server serving one of the invited users. Furthermore, where the users are widely dispersed, there may be a plurality of servers corresponding to respective groups of users, each one of the servers checking the meeting request as to its respective group of users. In such an instance, the results from the plurality of servers may be collected with the aggregate of the results determining whether or not there is a conflict.

For each invited user, the country, and preferably time zone as well, of their current location is obtained and made available to the calendaring server 450 or other device determining whether or not there is a conflict. The determination can be done based on information input by the invited user into their calendar application. Taking into account that such information may not be accurate because the invited user has moved temporarily or permanently without updating their information, other means may be employed to provide accurate location information. For example, the location of a user terminal may be obtained and used to determine to the country and time zone of the user whenever the user terminal connects to a communications network. The terminal can be configured so that it obtains the location and time zone information from the network, and the calendar application is automatically updated with this information. The location and time zone is thus available if the holiday information is accessed in step 603-2 or is transferred to the user calendar stored in an online calendar in a server separate from the user terminal the next time the online calendar is updated or synchronized with the user terminal. Alternatively, with respect to a mobile terminal such as a cell phone, any known locationing method (such as observed time differences (OTD) between signals of base stations in a cellular network or satellite based Global Positioning System (GPS), etc.) may be utilized to obtain the location of the user terminal and determine the country and time zone of the user.

The location, country and time zone information determined for users can also be used to automatically synchronize meeting requests involving users located in different time zones. For example, if an invited user moves suddenly from New York to London, and a meeting request involving that invited user is made soon thereafter by a requesting user who is unaware that the invited user has relocated, the updated country and time zone information of the invited user will be used when checking the meeting request to determine whether or not there is a conflict.

It is next determined in step 605 whether or not there is a conflict between the time and date of the requested meeting and the holiday information. This determination may be made by calendaring server 450 or by another device in the network. The requesting user may have the option, in the message request generation screen, displayed by the calendar application in the requesting user's terminal, of setting parameters by which it is determined whether or not there is an unacceptable conflict. For example, the requesting user may set a threshold of the number or percentage of users that may be permitted to have a holiday conflict. There may also be a threshold dependent on the invited users designated as essential.

If it is determined in step 605 that there is an unacceptable conflict, then the meeting request is not forwarded to the invited users. Instead, the requesting user is informed of that fact at step 611 by the server(s) making the determination. The report to the requesting user may include details of the circumstances that gave rise to the unacceptable conflict. The notification may or may not present the requesting user with alternative meeting requests that may be made. Instead of only sending a report when there is an unacceptable conflict as shown in FIG. 6, the requesting user may be informed of the determination made in step 605 regardless of the results (i.e., whether or not there is an unacceptable conflict).

If however it is determined in step 605 that there is not an unacceptable conflict, then the processing of the meeting request continues. In step 606, the meeting request is forwarded to the calendar applications of the invited users. Upon learning the date and time of the requested meeting, the text of the calendar entries of the invited users at the same time as the requested meeting are accessed in step 607. These text entries are then searched for certain keywords at step 608. The keywords may be predetermined or may be selected by the requesting user in the meeting request generation screen.

If keywords are discovered at step 609, then the requesting user is notified of this result at step 611. The results provided to the requesting user may include the text entries containing the keywords and an identification of the invited user corresponding to the text entry. If no keywords are found at step 609, then the method continues and the meeting request is permitted to be displayed to the invited users. The meeting planning may continue in a conventional manner, the invited users accepting or declining the meeting request as they normally would. Indeed, the invited users receiving the meeting request will be unaware of the processing carried out in conjunction with the meeting request prior to receiving the meeting request.

The invention has been described in terms of its preferred embodiments. It should be understood that numerous modifications may be made thereto without departing from the spirit and scope of the present invention. In particular, there may be a variety of different network implementations, and different degrees of distribution of user calendars among calendaring servers. In a large organization, there may be a large number of users and calendaring servers configured to serve a large plurality of different users. There may be intermediary and proxy servers utilized, and where communications are described between user terminals and calendaring servers in the preferred embodiments, it should be understood that there may be several series of communication hops before messages are transferred from the beginning device to the final destination device.

What is claimed is:

1. A user terminal comprising:
a processor;
a user interface;
at least one network interface, said network interface being operable to connect said user terminal to a communications network interconnecting a plurality of users and having a calendaring server storing holiday information; and
a memory, said memory storing a calendar application which provides a message request screen permitting said user to generate a meeting request, the meeting request identifying-users invited to the requested meeting and indicating a date and time for the requested meeting;
wherein said meeting request is included in a message transferred to said calendaring server via said at least one network interface to check if the meeting request conflicts with the holiday information stored in the calendaring server.

2. A user terminal as recited in claim 1, wherein said calendar application permits the user to set parameters used in the processing of said meeting request by said calendaring server.

3. A user terminal as recited in claim 2, wherein said calendar application allows the user to designate some of the invited users as essential.

4. A user terminal as recited in claim 2, wherein the holiday information stored in the calendaring server is updated according to the location of the invited users and the user terminal is configured to receive a message from the calendaring server indicating if the requested meeting conflicts with holidays at the location of the invited users.

5. A user terminal as recited in claim 2, wherein said calendar application allows the user to designate keywords to be searched by the calendaring server in the text of calendar entries of the invited users at the same time as the requested meeting.

6. A user terminal as recited in claim 1, wherein the user terminal has a plurality of different network interfaces, said network interfaces being operable to connect the user terminal to a plurality of different communications networks.

7. A user terminal as recited in claim 1, wherein the location and time zone information stored in the calendar application is updated automatically.

8. A user terminal as recited in claim 7, wherein the location and time zone information is updated automatically according to the information of a communications network when the user terminal is connected to the communications network.

9. A calendar application stored in a tangible medium, said calendar application when executed in a user terminal, causing the user terminal to:
connect to a calendaring server in a communications network serving a plurality of users, said calendaring server storing holiday information;
provide a message request screen permitting said user to generate a meeting request, the meeting request identifying users invited to the requested meeting and indicating a date and time for the requested meeting; and
include said meeting request in a message transferred to said calendaring server via said at least one network interface to check if the requested meeting conflicts with a holiday information stored in said calendaring server.

10. A calendar application as recited in claim 9, wherein said calendar application permits the user to set parameters used in the processing of said meeting request by said calendaring server.

11. A calendar application as recited in claim 10, wherein said calendar application allows the user to designate some of the invited users as essential.

12. A calendar application as recited in claim 10, configured to receive a message from the calendaring server indicating if the requested meeting conflicts with holidays at the location of the invited users.

13. A calendar application as recited in claim 10, wherein said calendar application allows the user to designate keywords to be searched by the calendaring server in the text of calendar entries of the invited users at the same time as the requested meeting.

14. A calendaring server, comprising:
a network connection adapted to received messages from user terminals over a communications network;
a database storing holiday information; and
a calendar application, wherein said calendar application
receives a message from a user terminal containing a meeting request, the meeting request identifying users invited to the requested meeting and indicating a date and time for the requested meeting
checks the database to determine whether or not the requested meeting conflicts with a holiday at the location of any of the invited users, and
forwards the meeting request to the invited users only if it is determined that there is not a conflict between the date and time of the requested meeting and the holidays at the location of the invited users.

15. A calendaring server as recited in claim 14, wherein said calendaring server updates said holiday information according to the location of the invited users.

16. A calendaring server as recited in claim 14, wherein said calendaring server accesses holiday information from the calendars of said invited users.

17. A calendaring server as recited in claim 14, wherein said calendaring server returns a message to the requesting user if there is a conflict between the date and time of the requested meeting and the holiday information at the location of the invited users.

18. A calendaring server as recited in claim 17, wherein the calendaring server uses parameters set by the requesting user for determining whether or not there is a conflict.

19. A calendaring server as recited in claim 14, wherein the calendaring server accesses and searches the text of the calendar entries of the invited users at the same time as the requested meeting to determine the presence of keywords.

20. A calendaring server as recited in claim 19, wherein the calendaring server returns a message to the requesting user if any of the keywords are discovered in the text of the calendar entries of the invited users.
